(19) United States
(12) Patent Application Publication
(10) Pub. No.: US 2002/0028698 A1
(43) Pub. Date: Mar. 7, 2002

(54) Display apparatus

(75) Inventor: Anders Linge, Kavlinge (SE)

Correspondence Address: Stanley R. Moore, Esq., JENKENS & GILCHRIST, P.C., 1445 Ross Avenue, Suite 3200, Dallas, TX, 75202-2799, US

(73) Assignee: Telefonaktiebolaget L M Ericsson (publ)

(21) Appl. No.: 09/944,778

(22) Filed: Aug. 30, 2001

(30) Foreign Application Priority Data
Sep. 6, 2000 (GB) 0021866.9

(51) Int. Cl. H04M 1/00

(52) U.S. Cl. 455/566; 455/550

(57) ABSTRACT

There is disclosed a portable communication device having a microdisplay. A second transmissive display is positioned in front of said first microdisplay.

The device is operable in a first display mode, in which the second display is activated and the microdisplay inactive, and in a second display mode, in which the microdisplay is activated, and the second display rendered transparent so that the microdisplay can be viewed through the second display.

This has the advantage of considerably reducing the total surface area and/or volume of the device needed for the display, and thus aids the development of smaller devices.

### TECHNICAL FIELD OF THE INVENTION

This invention relates to display apparatus, and particularly, although not exclusively, relates to handheld communication devices such as personal digital assistants (PDAs), radiotelephones and the like. More specifically, the invention relates to a handheld device having both a microdisplay and an at least partially transmissive display.

Description of Related Art

Current handheld electronic devices such as radiotelephones commonly have a transflective LCD liquid crystal display presently limited to displaying status information, memoranda and low resolution graphics. With the advent of higher-bandwidth networks and the associated increase in functionality of communications devices such as radiotelephones, the need is increasing for a relatively high-resolution visual display integrated into the telephone, suitable for viewing photographs, moving pictures, and Internet content. However, the small size of radiotelephones necessarily causes an associated display to be rather small.

The use of microdisplays in radiotelephones is already known. Included in the optics is a magnification system which compensates for the small image size by magnifying and projecting the corresponding virtual image at an appropriate distance for viewing. WO98/19435 discloses a cellular phone having a microdisplay and an alphanumeric display separate from the microdisplay. In this case, such an alphanumeric display is required in order to present to the user of the radiotelephone status information, memoranda and other visual information frequently required in a manner that is easily readable. Use of the microdisplay for this purpose would be inconvenient as the projected image from the microdisplay is only in focus when the microdisplay is positioned at distances of 1-2 cm from the user's eye. Transmissive LCD alphanumeric displays, on the other hand, may be read from distances of about 20-50 cm.

Such provision of a separate alphanumeric display in addition to a microdisplay necessitates additional space in the radiotelephone. The provision of a separate microdisplay, as described in the prior art, is contrary to the general desire for smaller mobile telephones.

Accordingly, there exists a need for presenting a user with a more easily readable compact visual display which is easily incorporated into radiotelephones and other electronic devices.

### SUMMARY OF THE INVENTION

In accordance with the invention there is provided a portable communication device having a first microdisplay and a second at least partially transmissive display in front of said first microdisplay, the first microdisplay being viewable through the second display, and the device being operable in a first display mode, in which the second display is activated and the first microdisplay inactive, and a second display mode, in which the microdisplay is activated, and the second display rendered transparent. This has the advantage of considerably reducing the total surface area and/or volume of the device needed for the display, and thus aids the development of smaller devices.

For instance, the second display may be a transflective LCD display, that is to say, a display that is partially reflective and partially transmissive (for instance, 80% reflective and 20% transmissive) making it possible to be viewed in a bright environment whilst maintaining sufficient contrast in a dark environment by means of a backlight disposed behind the display.

In an embodiment of the invention, the second display and the screen of the microdisplay are inclined to one another, and may be substantially perpendicular. Such an arrangement is space saving, allowing the overall size of the combined display to be reduced.

Preferably, the portable communication device is operable in a third display mode, in which the second display is activated and the microdisplay used as a backlight for said transmissive display. This has the advantage of saving cost and power, as a separate backlight system is not required for the transmissive display for use in dark environments.

In a preferred embodiment, the portable communications device is a radiotelephone. Status information and memoranda may be displayed on the transmissive display, whilst high-resolution graphics and motion video may be displayed on the microdisplay.

Thus, the system remains truly portable and allows the user greater functionality to access the Internet whilst retaining the convenience of modern portable electronic devices.

It shall be emphasised that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

For a better understanding of the present invention and to show how it may be carried into effect reference will now be made, by way of example, to the accompanying drawings, in which:

FIG. 1 is an elevated front view, in perspective, of a communications device having a combined transmissive display and microdisplay in accordance with the invention;

FIG. 2 is a schematic side view, in cross section, of a device having a combined transmissive display and microdisplay in accordance with the invention, illustrating use of the microdisplay.

FIG. 3 is a schematic side view, in cross section, of a device having a combined transmissive display and microdisplay in accordance with the invention, illustrating use of the transmissive display.

### DETAILED DESCRIPTION OF THE PREFERRED EMBODIMENTS OF The Invention

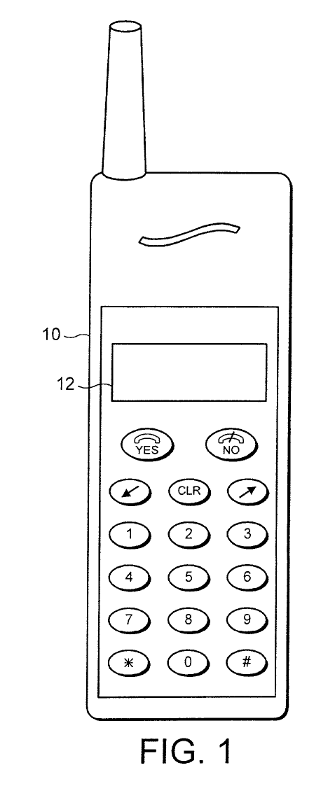

FIG. 1 shows a radiotelephone 10 used for voice communications and for accessing on-line services such as Internet content with suitable browser software. It is to be understood that the invention is equally applicable to other electronic equipment having a display system such as digital cameras, or a personal digital assistant (PDA), that is a handheld computer for personal use having a display, pen or keyboard input and software for organization, contact management, database and equipped with suitable communications means. The term electronic equipment includes portable radio communication equipment, such as mobile telephones, communicators, smartphones and pagers.

The radiotelephone 10 comprises a display 12 for presenting status information such as battery level, signal quality, telephone numbers and caller information, and further content such as high-resolution images, video and Internet content. The radiotelephone 10 further comprises other elements such as an antenna, microphone, speaker, keypad and battery as is known to those skilled in the art.

The radiotelephone includes a processor, under the control of operating software. The operating software preferably includes Internet browser software, allowing a user to access the Internet, or similar.

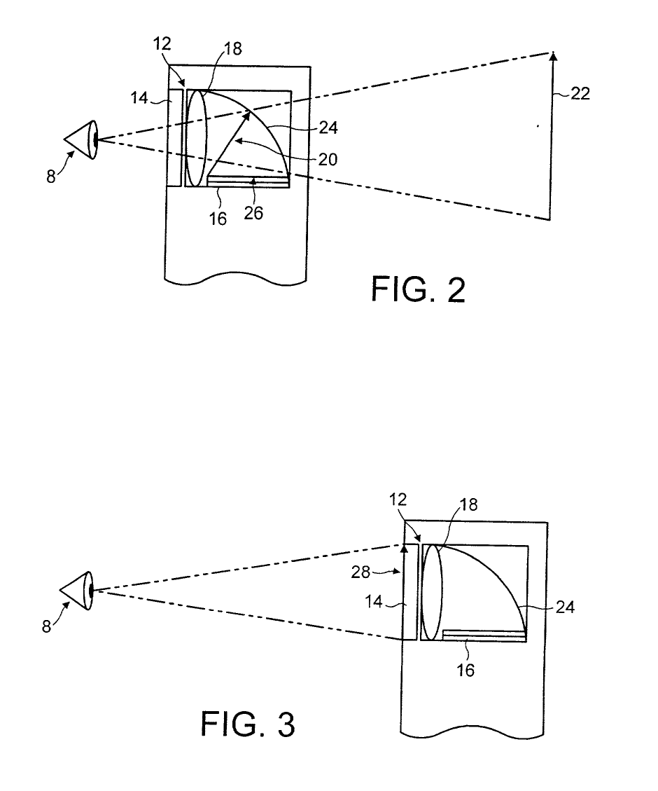

The structure of the combined display 12 is disclosed in more detail in FIGS. 2 and 3. The combined display 12 includes a low-resolution transflective display 14. Transflective display 14 is an LCD display as conventionally found on a mobile phone, or similar, and comprises a thin layer of liquid crystal material disposed between two parallel sheets of glass or other transparent material.

Combined display 12 further comprises a microdisplay 16, having a lens 18 and a curved mirror 24. As used herein, a microdisplay, as known from WO98/19435, is a miniature display, of resolution comparable to that found on a PC or laptop computer. For example, the display may be formed on a silicon backplane. Such a display requires magnifying optics such that when held in a user's hand, typically within the range of 1 cm to 3 cm of the user's eye, a sharp picture is visible as a virtual image.

In the present embodiment of this invention, microdisplay 16 comprises a screen 26 disposed substantially at right angles to transflective display 14. A source image is projected from screen 16 and reflected by curved mirror 24 onto a convex lens 18, or similar focussing means, to present a virtual image 22 appearing behind the plane of the microdisplay as viewed by the user 8. The transflective display 14 is made transparent in such an embodiment.

Advantageously, mirror 24 is substantially concave allowing screen 26 of microdisplay 16 to be disposed at right angles to transflective display 14. Mirror 24 however can be of a more complex shape, for instance to reduce or increase the degree of field curvature or other aberrations introduced by convex lens 18. Such an arrangement is space saving, allowing the overall size of the combined display 12 to be reduced. The shape of the mirror 24 and the position of the microdisplay 16 can be chosen to fit into any available space within the housing of the overall device.

Turning now to FIG. 3, the same apparatus is shown but the display is held at a greater distance from the eye 8, typically 20-50 cm. At this distance, the microdisplay is out of focus but an image 28 shown by the transmissive display is clearly visible. Thus, status information such as battery level, signal quality and caller identification may be read easily. The microdisplay 16 may be switched off to conserve power, or preferably may be used as a backlight. A backlight is an LED or array of LEDs placed behind or at the side of a display to illuminate the display in an environment where there is insufficient ambient light. Usually, a backlight system includes an optical system including a light guide that reflects and directs the light emitted by the LEDs through the display and into the direction of the viewer.

There is thus described a communications device, and a communications network access system, which provides for a portable high quality display in addition to a conventional transmissive LCD display in a manner which is space saving and compact.

It is to be understood that the above detailed description of preferred embodiments of the invention is provided by way of example only. Various details of design and construction may be modified without departing from the true scope of the invention as set forth in the appended claims.

1. A portable communications device having a first microdisplay and a second at least partially transmissive display in front of said first microdisplay.

2. A portable communications device as claimed in claim 1, wherein said second display and the screen of said microdisplay are inclined to one another.

3. A portable communications device as claimed in claim 2, wherein said second display and the screen of said microdisplay are disposed substantially perpendicular to one another.

4. A portable communications device as claimed in claim 1, wherein the second display and the first microdisplay may be operated independently.

5. A portable communications device as claimed in claim 1, wherein the microdisplay can serve as a backlight for said second display.

6. A portable communications device as claimed in claim 1, wherein the second display may be made substantially transparent when not in use.

7. A portable communications device as claimed in claim 1, wherein said second display is a transflective display.

8. A portable communications device as claimed in claim 7, wherein said transflective display is a transflective liquid crystal display (LCD).

9. A portable communications device as claimed in claim 1, wherein said portable communications device is a radiotelephone.

10. A radiotelephone as claimed in claim 9, wherein status information and memoranda may be displayed on said second display.

11. A radiotelephone as claimed in claim 9, wherein high-resolution graphics may be displayed on said microdisplay.

12. A radiotelephone as claimed in claim 9, wherein motion video may be displayed on said microdisplay.

13. A portable communications device having a first microdisplay and a second at least partially transmissive display in front of said first microdisplay, the first microdisplay being viewable through the second display, and the device being operable in a first display mode, in which the second display is activated and the first microdisplay inactive, and a second display mode, in which the microdisplay is activated, and the second display rendered transparent.

14. A portable communications device as claimed in claim 13, wherein said second display is a transflective liquid crystal display (LCD).

15. A portable communications device as claimed in claim 14, wherein said first face and said second face are inclined to one another.

16. A portable communications device as claimed in claim 15, wherein said first face and said second face are disposed substantially perpendicular to one another.

17. A portable communications device as claimed in claim 13, further operable in a third display mode, in which the second display is activated and the first microdisplay used as a backlight for said second display.

18. A portable communications device as claimed in claim 13, wherein said portable communications device is a radiotelephone.

19. A radiotelephone as claimed in claim 18, wherein status information and memoranda may be displayed on said second display.

20. A radiotelephone as claimed in claim 18, wherein high-resolution graphics may be displayed on said microdisplay.

21. A radiotelephone as claimed in claim 18, wherein motion video may be displayed on said microdisplay.

22. A method for displaying an image in a portable communications device, comprising the steps of reading a signal from a microprocessor and operating a display in a first mode, in which a first microdisplay is activated and a second at least partially transmissive display inactive, and a second mode, in which the first microdisplay is activated, and the second display rendered transparent, wherein said second display is disposed in front of said first microdisplay.

23. A method for displaying an image in a portable communications device as claimed in claim 22, wherein said second display and the screen of said first microdisplay are inclined to one another.

24. A method for displaying an image in a portable communications device as claimed in claim 23, wherein said second display and the screen of said first display are disposed substantially perpendicular to one another.

25. A method for displaying an image as claimed in claim 22, further having a third mode, in which the second display is activated and the first microdisplay used as a backlight for said second display.

26. A method for displaying an image as claimed in claim 22, wherein status information and memoranda may be displayed on said second display.

27. A method for displaying an image as claimed in claim 22, wherein high-resolution graphics may be displayed on said first microdisplay.

28. A method for displaying an image as claimed in claim 22, wherein motion video may be displayed on said first microdisplay.
